(19) United States
(12) Patent Application Publication
(10) Pub. No.: US 2014/0087230 A1
(43) Pub. Date: Mar. 27, 2014

(54) CASING DEVICE FOR AN ENERGY STORAGE DEVICE AS WELL AS AN ARRANGEMENT COMPRISING SAID CASING DEVICE AND SAID ENERGY STORAGE DEVICE

(71) Applicant: Li-Tec Battery GmbH, Kamenz (DE)

(72) Inventor: Tim Schaefer, Harztor (DE)

(73) Assignee: Li-Tec Battery GmbH, Kamenz (DE)

(21) Appl. No.: 14/035,224

(22) Filed: Sep. 24, 2013

Related U.S. Application Data
(60) Provisional application No. 61/704,598, filed on Sep. 24, 2012.

(30) Foreign Application Priority Data
Sep. 24, 2012 (DE) 10 2012 018 839.0

(51) Int. Cl. H01M 2/10

(52) U.S. Cl. CPC H01M 2/1094
USPC 429/100; 429/96; 29/623.1

(57) ABSTRACT

A casing device for an energy storage device, comprising:
(a) a casing wall, particularly a membrane, by means of which a receiving space for accommodating the energy storage device can be delimited in water-tight manner,
(b) a closable, particularly reclosable, first access opening formed in the casing wall for passing the energy storage device into and out of the receiving space,
(c) wherein the casing wall exhibits a first vapor-permeable wall section and particularly a second wall section,
(d) wherein particularly the first and the second wall section form a complementary partitioning of the casing wall.

The present application claims the benefit of U.S. Provisional Patent Application Ser. No. 61/704,598, filed Sep. 24, 2012, the entire content of which is incorporated herein by reference. The present application also claims priority to German Patent Application 10 2012 018 839.0, filed Sep. 24, 2012, the entire content of which is incorporated herein by reference.

The present invention relates to a casing device for an energy storage device, particularly a casing device for protecting the energy storage device from moisture, as well as an arrangement comprising said casing device and said energy storage device. The invention is described in conjunction with lithium-ion batteries for supplying motor vehicle drives. It is noted that the invention can also be used independent of the specific battery design or electrochemical energy storage device chemistry or independent of the type of drive supplied.

Energy storage devices particularly designed with a plurality of storage cells capable of providing electrical energy to a load, particularly by means of electrical connection devices, including those designed as cables, conductor lines, busbars, etc. are known in the prior art. Short circuits can occur with such energy storage devices, particularly when there is high moisture content in the environment of the energy storage device.

One objective of the invention is enabling the safer operation of such an energy storage device.

This objective is accomplished by a casing device in accordance with claim 1. Claim 14 describes an arrangement comprising the casing device and the energy storage device. The objective is also accomplished by a method for protecting said energy storage device in accordance with claim 17. Preferential further developments of the invention constitute the subject matter of the subclaims.

In accordance with the invention, the casing device comprises a casing wall, at least sections of which in particular are configured as a membrane. The casing wall enables the delimiting of a receiving space which serves to accommodate the energy storage device in water-tight manner. A closable, particularly reclosable, first access opening is formed in the casing wall for passing the energy storage device into and out of the receiving space. The casing wall exhibits a vapor-permeable first wall section and in particular a second wall section. Particularly the first wall section and the second wall section form a complementary partitioning of the casing wall.

Sensitive parts of energy storage devices are often protected by protective devices, particularly designed as plastic caps, shrink tubing or the like. Using Vaseline or battery grease is alternatively also known, particularly for maintenance purposes.

By the casing device comprising a first vapor-permeable wall section, particularly vaporous moisture can be discharged into the environment from the casing device. The influx of environmental moisture through the casing wall is further countered. Hence, a casing device in accordance with the invention is suited to creating an atmosphere able to counter a moisture-triggered short circuit in an energy storage device, thus accomplishing the underlying objective.

In the terms of the invention, a casing device is to be understood particularly as a device substantially realized by the casing wall which is suited to at least partly encasing, ensheathing or enclosing the energy storage device, wherein the casing wall is designed preferably as a membrane; i.e. in the form of a separating layer which separates the three-dimensional space into an interior, the receiving space for accommodating the energy storage device, and an exterior.

In the terms of the invention, a casing wall is to be understood as a device which is particularly suited to delimiting the receiving space in water-tight manner, although is permeable to vapor, particularly water vapor, at least in the area of its first wall section such that, as a whole, the casing wall is semi-permeable. The water-tight delimiting of the receiving space arises from the fact of the casing wall comprising an opening, the first access opening, in order to allow the energy storage device to be placed into the casing device, particularly for the first time or particularly anew in the context of replacement or repair, and/or removed from the casing device. To this end it is particularly necessary to be able to likewise close the first access opening so as to be water-tight after the energy storage device has been placed into the casing device.

In the terms of the invention, a receiving space is to be understood as a space which particularly serves in at least partly, preferably substantially fully, accommodating one of said energy storage devices. The receiving space is for the most part, preferably substantially fully, enclosed by the casing wall. The receiving space is for the most part, preferably substantially completely, arranged within the casing wall.

In the terms of the invention, “water-tight” is particularly to be understood as at least one wall section of the casing wall preventing water and/or atmospheric moisture from infiltrating into the receiving space from the outside. Fluid, however, particularly vaporous fluid, in particular water or water vapor, can pass through the casing wall from the interior to the exterior. Hence, the casing wall can be a wall which is unidirectionally permeable to water or water vapor. It is thus not only possible but in fact advantageous for water which is present after the first access opening in the receiving space is closed to permeate the casing wall to the outside if the osmotic conditions are in place; i.e. particularly if the atmospheric moisture in the receiving space is higher than that outside. In the terms of the invention, other vaporable, particularly electrically conductive, liquids are also to be considered as water. Preferably the first access opening comprises a plurality of openings.

In the terms of the invention, a first access opening is to be understood as a device which particularly enables the introducing of the energy storage device into the receiving space and the removal of the energy storage device from the receiving space. The first access opening is of closable, particularly reclosable, design. The first access opening is particularly designed so as to close in water-tight manner.

In the terms of the invention, a first wall section refers to a section of the casing wall which is permeable particularly to vapor or water vapor.

In the terms of the invention, a second wall section refers to a section of the casing wall which is impermeable particularly to vapor or water vapor.

The casing wall is divided into the first and the second wall section, whereby the entirety of all the vapor-permeable areas of the casing wall form the first wall section and the remaining areas of the casing wall form the second wall section, thereby yielding the complementarity to the first and second wall section. In other words, if one designates the casing wall as M and the first/second wall section as A1 and A2, then M=A1+A2.

In the terms of the invention, a “need-adaptive release of energy” is essentially to be understood as the supplying of a, particularly independent, load over a predefined period of time or a predefined time frame.

Water in the sense of the invention also includes other, particularly vaporable, particularly electrically conductive, liquids.

The following will describe preferential further developments of the invention.

In accordance with one preferential further development, the second wall section is designed as a substantially cuboid, particularly two-part housing for accommodating one of said energy storage devices and the first wall section as a fluid exchange device, particularly for ventilating, aerating and/or dehumidifying the housing. The housing and the fluid exchange device together delimit the receiving space such that a fluid exchange for compensating a pressure difference between the receiving space and the environment is advantageous. The housing is preferably designed with at least one metal wall and/or in particular fiber-filled plastic wall. The present preferential development provides the advantage of the housing being able to provide a minimum mechanical protection to the energy storage device.

Preferably the housing comprises an opening for the fluid exchange device. Preferably the fluid exchange device is designed with a Gore-Tex membrane. Preferably the fluid exchange device is arranged in the housing wall's opening. Preferably the housing and the fluid exchange device can have a material connection.

Alternatively, the fluid exchange device is arranged as a seal between the two parts of the two-piece housing.

The present preferential development provides the advantage of improving the ventilating, aerating and/or dehumidifying during the operation of the energy storage device, particularly its stationary use. This preferential development provides the advantage of the first wall section being able to improve the sealing of the housing. This preferential development provides the advantage of being able to counter a pressure difference between the housing and the environment as can occur during the operation of the energy storage device by means of the fluid exchange device.

In accordance with an alternative preferred further development, the second wall section is of film-like design. In all other respects, the alternative preferred development corresponds to the afore-mentioned preferred development with housing. The present preferred development provides the advantage of improving ventilating, aerating and/or dehumidifying during the operation of the energy storage device, particularly its stationary use. This preferential development provides the advantage of the first wall section being able to improve the sealing of the housing. This preferential development provides the advantage of being able to counter a pressure difference between the housing and the environment as can occur during the operation of the energy storage device by means of the fluid exchange device.

In accordance with one preferred further development of the present invention, the first access opening is formed by a particularly zipper-like separation of the casing wall which extends along an open or closed line extending through the first and/or the second wall section.

This firstly means that the location of the casing wall's separation is independent of the allocating of the casing wall into the first and second wall section; i.e. the first access opening extends in particular either only into the first wall section or only into the second wall section or else crosses a boundary line between the first and second wall section.

While an open line is a line with a starting point and a terminus, this is not the case with a closed line.

Since the water-tightness to the casing wall is conditionally the same for all of its closed openings, the first access opening is particularly designed to be closable and in particular reclosable. The “reclosability” of the first access opening means that it can be opened and closed more than once, in particular in unlimited repetitions, whereby as stated above, it is water-tight when closed. The first access opening is in particular designed as a type of zipper, particularly a type of toothless zipper. Yet any differently designed opening having the above-cited features is likewise possible such as for instance an overlapping structure or a combination of same with the variants described above. Preferably a separation is particularly a disbanding or abolishing of the material connectivity along the line, in particular perpendicular to a plane of the bracing casing wall.

In accordance with one preferential further development of the present invention, the first access opening extends
(a) substantially linearly along the open line, or
(b) along the open line and divides the casing wall into a third wall section, a cover section particularly formed by at least one flap-like element, and a fourth wall section fixedly connected to said third wall section, or
(c) along the closed line and divides the casing wall into a third wall section, a cover section which is in particular removable, and a fourth wall section, particularly a wall section forming a counterpart to the cover section.

Preferably the third and the fourth wall section according to (b) and (c) form a complementary partitioning of the casing wall.

The line according to variant (b) has—in contrast to the line according to variant (a)—a curvature such that the direct connecting line between the start and end point of the line is shorter than the line itself and is suitable as a transition line for the third wall section (cover section) of the casing wall delimited by the connecting line and the line. With the notation established above, the supplementary section A4 follows as A4=M−A3. The line according to variant (b) is preferably U-shaped or V-shaped or spoon-shaped in the manner of the chocolate bar known as a cat's tongue. In variant (c), the cover section becomes a detachable or removable cover section of preferably circular, rectangular, elliptical, etc. shape.

It is to be noted that the shape to the cover section depends on the three-dimensional shape of the casing wall. If the casing wall forms a cuboid, even if not self-supporting, then the first access opening is preferably formed in one of its six walls such that the cover section forms for example a Euclidean triangle. On the other hand, if the casing wall has for example a spherical shape instead of a rectangular shape, the triangular form of the cover would then not be Euclidean as it cannot “lie flat on a flat surface” so to speak.

Preferably the shape of the casing device corresponds to the peripheral shape of the energy storage apparatus with slightly larger dimensions. The third and the fourth wall section are mutually complementary just like the first and the second wall section. That is, in mathematical terms, the first and the second wall section form a first overlapping of the surface of the casing wall and the third and the fourth wall section form a second overlapping of the surface of the casing wall, wherein the first and the second overlap can be different and are in particular independent of one another. Preferably, however, the second opening is entirely within the second wall section so that the material of the second wall section can be optimally selected for particularly this purpose; i.e. the selection not needing to consider the material of the first wall section in particular.

Alternatively to the case described above in which the energy storage device is introduced “through” the first access opening “into” the receiving space so that it is arranged “entirely” within the casing device after the first access opening is closed and enclosed by same; i.e. completely within the receiving space, it is likewise advantageous for the boundary of the first access opening to be enclosed by a rigid, particularly one-piece or multi-piece frame which extends along the boundary and can be tightly connected in water-tight manner to a corresponding peripheral edge of the energy storage device, particularly by means of an O-ring seal or the like. So doing enables a surface of the energy storage device, preferably made of steel, delimited by the peripheral edge to act as part of the casing and allows, with the appropriate fastening means, optimum fastening and position fixing of the energy storage device at its predetermined location. The frame acts in this way particularly as a tentering frame for the casing wall.

In accordance with one preferential further development of the present invention, at least the first wall section of the casing wall comprises at least one inner layer and one outer layer, particularly in the nature of a Gore-Tex membrane.

The inner layer is particularly endowed with the feature of vapor-permeability while the outer layer, which in particular overlaps at least one area of the inner layer can be designed to provide mechanical or thermal protection to the inner layer. The inner and the outer layer can be directly connected together or a space can be formed between them in which preferably a damping material can be disposed to mechanically protect the energy storage device against impacts, etc.

In accordance with one preferential further development of the present invention, the casing device comprises a second access opening for a substantially water-tight enclosing of a penetrative element, particularly an electrical connection device for establishing an electrical connection, particularly a power connection and/or a control connection to the energy storage device, preferably at least one cable, wherein the second access opening is part of the third or fourth wall section.

The same requirements as far as watertightness naturally have to apply to the second access opening in order to ensure the watertightness of the casing device as a whole. The second access opening serves in particular in realizing the electrical connection device in order to be able to electrically connect all the particularly cable-based electrical devices located in the receiving space to the corresponding electrical devices external of the casing device.

Although the present invention relates to a “casing device for an energy storage device,” the inventive casing device is however also preferably suited to accommodating in addition to the energy storage device, further electrical or non-electrical devices (in the receiving space) which can have a functional relationship with the energy storage device, albeit such a relationship is not mandatory; thus, for all intents and purposes, the casing device can be termed a multi-functional protective device.

The term “electrical” includes any form of current and/or signal transmission required in charging and/or load-based discharging of the energy storage device as well as the controlling of these processes. The general term “penetrative element” refers to more than just the electrical connection device including for instance mechanical fixing agents which pass through the casing wall in order to fix the casing device and/or said casing wall. The electrical connection device penetrates the third or fourth section as the second access opening is formed therein. Preferably the electrical connection device is guided through either the “cover” or through the “cap,” although not through both. Most advantageous is the arrangement in the fourth wall section (“cap”).

The second access opening preferably comprises a plurality of openings. This can be advantageous when a plurality of energy storage devices are arranged in the receiving space and being able to access them from different points in the casing wall is beneficial.

In accordance with one preferential further development of the present invention, the casing device comprises an edge region bordering the second access opening which
is formed from a rubber-like material, whereby the rubber-like area is suited to enclosing the penetrative element in water-tight manner, or
is formed from a material which can contract when heated and/or expand when cooled, or
is formed from a thermoplastic or a shape-memory polymer.

Instead of the rubber-like material, a functionally equivalent material can be used which contracts upon heating, particularly in the manner of shrink tubing or the like, and in so doing achieves a water-tight site of passage for the penetrative element.

As the material not only contracts when warmed but also expands when cooled, the second access opening is not only closable but particularly also reclosable. Attention however needs to be paid particularly to the low temperature required hereto being outside of the normal operating range of the electrical devices to be protected from moisture. Applicable materials are thermoplastic or shape-memory polymer.

In accordance with one preferential further development of the present invention, the casing device comprises a sensor device for detecting moisture, particularly atmospheric moisture in the receiving space, and particularly also the temperature of the receiving space, wherein the sensor device is preferably arranged within the casing device.

The sensor device is preferably arranged either in the casing device; i.e. inside the receiving space, or, alternatively, integrated into the casing wall. The sensor device can detect a plurality of operating parameters of an electrical device disposed in the receiving space, particularly the energy storage device, and/or parameters of the receiving space and exterior space, particularly the atmospheric moisture and/or the temperature in the receiving space. The sensor device is particularly a part of the energy storage device or the casing device or a separate, particularly independent and exchangeable part. Preferably the sensor device additionally detects the forming of particularly dangerous gases during the operation of the energy storage device.

The sensor device is designed to at least intermittently furnish a measured value of the humidity, the atmospheric moisture and/or the temperature of the receiving space.

Preferably the sensor device is disposed adjacent to the vapor-permeable first wall section or the membrane respectively. It is particularly preferential for the sensor device to be integrated into the vapor-permeable first wall section or membrane respectively. Preferably the sensor device for detecting the integrity of the first wall section is designed as a fiber, electrically conductive wire or optical fiber sensor which in particular ruptures above a minimum elongation. The present preferred design provides the advantage of being able to detect damage to and/or ripping of the first wall section or membrane respectively, particularly also in more harsh environments, particularly by means of sensor device failure.

In accordance with one preferential further development, the sensor device is disposed outside of the casing device, particularly for detecting moisture. Preferably the sensor device is arranged on or adjacent one of the electrical connection devices. This preferred development provides the advantage of being able to have a warning or being able to initiate remedial action, particularly switching on an independent pump, when moisture is detected in the vicinity of the casing device.

In accordance with one preferential further development of the present invention, the casing device further comprises a radio device, particularly a short-range radio device.

A signal path can thus be created from and to the energy storage device and/or from and to a further electrical device in the receiving space in wireless (claim 8) and/or wired (claim 5) form. Preferably the wired connection serves in the transmitting of electrical power while the wireless (radio) connection serves in the transmitting of control signals and/or detection signals for the detecting of energy storage apparatus operating parameters. Preferably the wired connection can be additionally used to transmit the control and/or detection signals in the event the wireless connection malfunctions. In particular, the control and/or detection signals can be transmitted via wired and/or wireless connection.

In accordance with one preferential further development of the present invention, the casing device comprises a pump connection device. A particularly independent pump is connectable via the pump connection device, particularly for generating a negative pressure in the receiving space, particularly by aspirating at least a portion of the volume of gas confined by the casing device, particularly for aspirating a volume of fluid from the receiving space.

This has in particular the advantage of being able to suction out some of the moisture when relatively high atmospheric moisture is introduced into the energy storage device during its problem-free operation and connection and the casing device is thereafter closed so as to be water-tight.

In accordance with one preferential further development of the present invention, the casing device comprises fastening means, particularly at least one loop or eye or the like, for fixing the position of the casing device, one of the electrical devices disposed therein and/or the energy storage device.

Preferably the fastening means penetrates the casing wall in water-tight manner in order to secure an electrical device situated in the receiving space, particularly the energy storage device, at a predetermined position. As described above, the anchoring can also engage with a part of the energy storage device, particularly a surface, without penetrating the casing wall as the surface is integrated into or a part of the casing wall.

In accordance with the present invention, one arrangement comprises a casing device having at least one of the above-described features and an energy storage device, wherein the energy storage device is in particular a battery having at least one electrochemical storage cell, particularly a rechargeable battery, for the storing and need-adaptive releasing of electrical energy.

Preferably the energy storage device is rechargeable. Preferably the energy storage device is designed to convert supplied electrical energy into chemical energy. Preferably the energy storage device is designed to convert particularly stored chemical energy into electrical energy and provide it as electrical energy. Preferably the energy storage device comprises a plurality of particularly interconnectable storage cells. Preferably the energy storage device comprises two connections of different polarity at least intermittently in contact with the terminal voltage of the energy storage device, particularly the interconnected storage cells. Preferably the respective connections of the energy storage device are designed so as to be electrically connected to one of said electrical connection devices. Preferably the energy storage device, particularly at least one of its storage cells, comprises lithium and/or lithium ions.

Preferably the energy storage device or at least one of its storage cells has a charging capacity of at least 3 ampere-hours [Ah], further preferentially of at least 5 Ah, further preferentially of at least 10 Ah, further preferentially of at least 20 Ah, further preferentially of at least 50 Ah, further preferentially of at least 100 Ah, further preferentially of at least 200 Ah, further preferentially of at the most 500 Ah. This design provides the advantage of improving the operating duration of the load supplied by the energy storage device or at least one of its storage cells.

Preferably a current of at least 50 A, further preferentially of at least 100 A, further preferentially of at least 200 A, further preferentially of at least 500 A, further preferentially of at the most 1000 A can be at least intermittently withdrawn from the energy storage device or at least one of its storage cells, preferably over at least one hour. This design provides the advantage of improving the efficiency of the load supplied by the energy storage device or at least one of its storage cells.

Preferably the energy storage device or at least one of its storage cells can at least intermittently provide a voltage, particularly a terminal voltage, of at least 1.2 V further preferentially of at least 1.5 V, further preferentially of at least 2 V, further preferentially of at least 2.5 V, further preferentially of at least 3 V, further preferentially of at least 3.5 V, further preferentially of at least 4 V, further preferentially of at least 4.5 V, further preferentially of at least 5 V, further preferentially of at least 5.5 V, further preferentially of at least 6 V, further preferentially of at least 6.5 V, further preferentially of at least 7 V, further preferentially of at the most 7.5 V. It is particularly preferable for the energy storage device or at least one of its storage cells to comprise lithium and/or lithium ions. This design provides the advantage of improving the energy density of the energy storage device or at least one of its storage cells.

Preferably the energy storage device or at least one of its storage cells can be operated at least intermittently, particularly over at least one hour, at an ambient temperature of between −40° C. and 100° C., further preferentially between −20° C. and 80° C., further preferentially between −10° C. and 60° C., further preferentially between 0° C. and 40° C. This design provides the advantage of the most unrestricted positioning or use of the energy storage device or at least one of its storage cells to supply a load, particularly a motor vehicle or a stationary system or machine.

Preferably the energy storage device or at least one of its storage cells has a gravimetric energy density of at least 50 Wh/kg, further preferentially of at least 100 Wh/kg, further preferentially of at least 200 Wh/kg, further preferentially of less than 500 Wh/kg. Preferably the energy storage device comprises lithium ions. This design provides the advantage of improving the energy density of the energy storage device or at least one of its storage cells.

In accordance with one preferred embodiment, the energy storage device or at least one of its storage cells is provided for installation into a vehicle having at least one electric motor. Preferably the energy storage device or at least one of its storage cells is provided for supplying said electric motor. It is particularly preferential for the energy storage device or at least one of its storage cells to be provided to at least intermittently supply an electric motor of a hybrid or electric vehicle's drive train. This design offers the advantage of improving the supplying of the electric motor.

In accordance with a further preferred embodiment, the energy storage device or at least one of its storage cells is provided for use in a stationary battery, particularly in a buffer storage, as a device battery, industrial battery or starter battery. The charging capacity of the energy storage device or at least one of its storage cells for these applications preferably amounts to at least 3 Ah, particularly preferably to at least 10 Ah. This design provides the advantage of improving the supplying of a stationary load, particularly a stationary mounted electric motor.

In the case of energy storage devices having a plurality of storage cells connected in series, one of said electrical connection devices of first polarity of a first of said storage cells can be disposed in the vicinity of a second of said electrical connection devices of opposite polarity of a second of said storage cells. A drop of liquid coming into contact with these two electrical connection devices can thereby cause a short circuit within the energy storage device. The energy storage device being enclosed by the casing device, however, counters such short-circuiting, thus accomplishing the invention's underlying objective.

A “need-adaptive release” of energy is essentially a supplying of a load during a predetermined time period and/or over a predetermined time frame.

In accordance with one preferential further development of the present invention, the energy storage device is connected, particularly via the electrical connection device, to an energy storage device management system (EMS) for controlling the energy storage and/or energy dispensing operations of the energy storage device, in particular as a function of at least the moisture, atmospheric humidity and/or temperature detected by the sensor device. To this end, the electrical connection device extends through the water-tight closed second access opening. The energy storage device management system takes over the essential, particularly all of the functions for the continuous operation of the energy storage device; i.e. including charging.

Preferably the EMS is designed to exchange signals with the sensor device and/or an independent control device, particularly by means of one of said radio devices. Preferably the EMS is designed to at least intermittently receive at least one of said measured values from the sensor device, particularly by means of one of said radio devices. Preferably the EMS is additionally designed to prompt the sensor device to detect at least one of said measured values, particularly by means of one of said radio devices.

In accordance with one preferential further development, the energy storage device management system can be wholly arranged in the receiving space, and particularly there operate completely autonomously, or arranged partially or wholly outside of the receiving space, and particularly there operate completely autonomously or semi-autonomously or non-autonomously; i.e. only by explicit command input by an operator.

According to the present invention, a method for protecting an energy storage device having a casing device with at least one of the above-described features, comprises the steps of:
(I) opening the first access opening and arranging the energy storage device in the casing device,
(II) passing one of said electrical connection devices through one of said second access openings,
(III) electrically connecting the electrical connection device to the energy storage device and closing the second access opening in substantially water-tight manner,
(IV) closing the first access opening, and
(V) aspirating a volume of fluid, particularly a portion of a gas present in the receiving space, out of the receiving space, in particular generating a negative pressure in the receiving space, particularly by means of an independent pump.

In step III, preferably at least two of said electrical connection devices of different electrical polarity are connected to different connections of the energy storage device.

This method provides the advantage of countering the influx of moisture from the environment of the casing device.

In accordance with one preferential further development of the method, an independent pump is preferentially particularly actuated when the sensor device, particularly arranged within the casing device, detects moisture. This preferential development of the method provides the advantage of the removal of moisture from the interior of the casing device being able to be initiated by the pump based on need.

In the case of energy storage devices having a plurality of storage cells connected in series, one of said electrical connection devices of first polarity of a first of said storage cells can be disposed in the vicinity of a second of said electrical connection devices of opposite polarity of a second of said storage cells. A drop of liquid coming into contact with these two electrical connection devices can thereby cause a short circuit within the energy storage device. The energy storage device being enclosed by the casing device, however, counters such short-circuiting, thus accomplishing the invention's underlying objective.

Further advantages, features and possible applications of the present invention will follow from the description below in conjunction with the figures, which show:

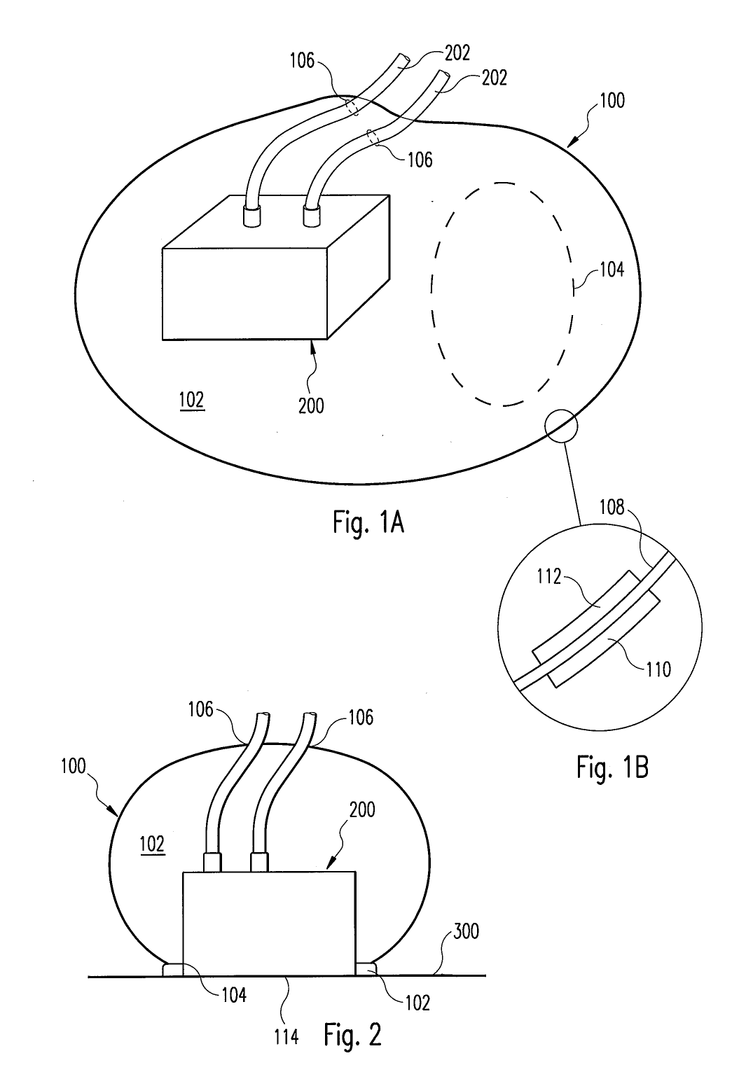

FIG. 1 a schematic, perspective view according to a first preferential embodiment of a casing device having a battery accommodated therein as an energy storage device,

FIG. 2 a schematic sectional view according to a further preferential embodiment of a casing device having a battery accommodated therein as an energy storage device,

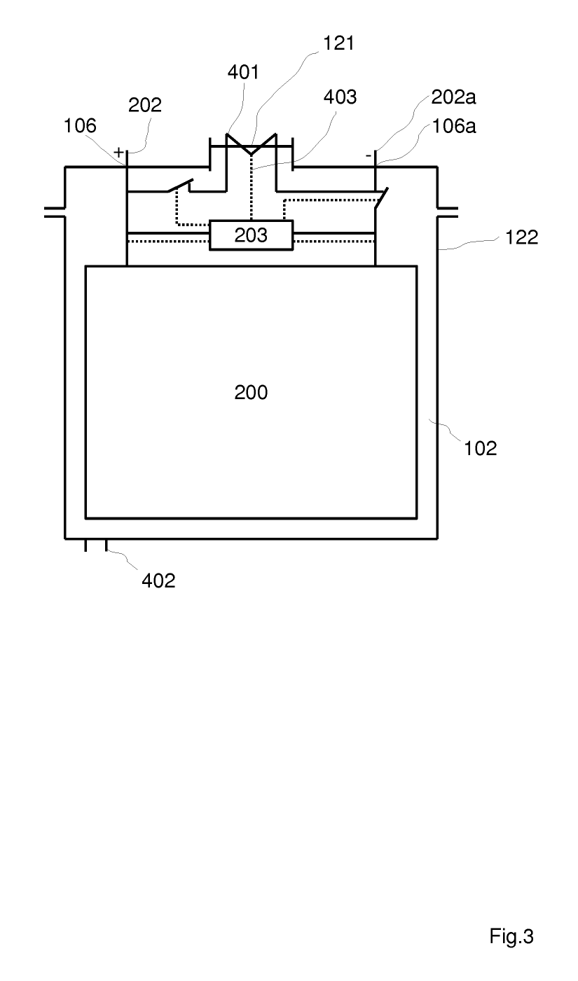

FIG. 3 a schematic sectional view according to a second further preferential embodiment of a casing device having a battery accommodated therein as an energy storage device.

In schematic and very sketched manner, FIG. 1A shows a perspective view according to a first preferential embodiment of a casing device 100 having a battery 200 as an energy storage device accommodated in a receiving space 102 it delimits.

The casing device 100 encloses the battery 200 completely and comprises a first access opening 104, depicted with dashes, through which the battery 200 can be introduced into and withdrawn out of the receiving space 102. The casing device 100 further comprises two second access openings 106, likewise depicted with dashes, through which the electrical cable 202 is guided which can produce an electrical connection between the battery 200 and an external electrical device (not shown). As described above in detail, the first access opening 104 can be closed in water-tight manner and the second access openings 106 comprise a suitable sealant (not shown), by means of which the site of passage of the electrical cable 202 is likewise water-tight.

As FIG. 1B shows, the casing device 100 exhibits a membrane 108 which is impermeable to water, although permeable to vapor. A bearing 110 or bearing 112 respectively is connected to the membrane 108 at well-defined wall sections of an outer surface of the membrane 108 and to the wall section of an inner surface of the membrane 108 corresponding to the wall sections of the outer surface. The bearings 110, 112 serve in protecting the membrane 108 from mechanical damage from an external retaining device (not shown; preferably a plate or a table) and the battery 200 (particularly from its own weight) when the latter is affixed to or on the retaining device. On wall sections corresponding to the four lower corners of the battery 200, the casing device 100 preferably comprises a respective bearing 112 arranged on the inner side of the membrane 108 (in the receiving space) and a respective bearing 110 arranged on the outer side of the membrane 108, and the battery 200 enclosed by the casing device 100 is arranged on a (not shown) retaining device such that the battery 200 is supported on the bearings 110, 112. Preferably the battery 200 is braced or the like by a (not shown) bow-shaped structure, wherein bearings 110, 112 are likewise arranged at the point of contact of the bow-like structure on the battery 200/casing device 100.

FIG. 2 shows a schematic sectional view according to a further preferential embodiment of the casing device 100 having a battery 200 accommodated therein as an energy storage device. The battery 200 rests directly on a support 300 and is braced by a frame 102 at its lower wall section 114 which is a part of the casing device 100. As FIG. 2 shows, the lower wall section 114 of the battery 200 itself forms a part of the casing device 100 as illustrated by reference numeral “114.” The frame 102 delimits the first access opening 104 of the membrane 108 or casing device 100 respectively through which the battery 200 can be introduced into and withdrawn out of the receiving space 102.

FIG. 3 is a schematic sectional view according to a further preferred embodiment of a casing device 100 with an energy storage device 200 accommodated therein.

The second wall section 122 is configured as a substantially rectangular housing for receiving the energy storage device 200 and the first wall section 121 as a fluid exchange device, particularly for ventilating, aerating and/or dehumidifying the housing 122. The housing 122 and the fluid exchange device 121 together delimit the receiving space 102 so as to support the exchange of fluid to offset a difference in pressure between the receiving space 102 and the environment. The housing 122 is designed with a fiber-filled plastic wall and comprises an opening. The fluid exchange device 121 is arranged in the opening and designed with a Gore-Tex membrane. At least sections of the housing 122 and the fluid exchange device 121 are materially connected.

The casing device 100 comprises a sensor device 401. The sensor device 401 is configured with an electrically conductive wire and connected to the fluid exchange device 121. The electrically conductive wire is designed such that it can indicate a failure of the fluid exchange device 121, that it can rupture particularly simultaneously with the fluid exchange device 121. The sensor device 401 is signal-connected to the energy storage device management system 203 by means of the radio device 403. The sensor device 401 can be supplied with electrical energy from the energy storage device 200, particularly at the instigation of the energy storage device management system 203, particularly by means of a controllable switch.

Two of said electrical connection devices 202, 202a are led through two of said second access openings 106, 106a and electrically connected to the energy storage device 200. The electrical voltage, particularly the terminal voltage, of the energy storage device 200, can be at least intermittently tapped at the electrical connection devices 202, 202a, particularly at the instigation of the energy storage device management system 203, particularly by means of a controllable switch.

The second wall section 122 comprises one of said pump connection devices 402 which is advantageously arranged particularly deep on the second wall section 122 during the operating state.

The energy storage device management system 203 is signal-connected, depicted as dotted lines, to the electrical connection devices 202, 202a, sensor device 401, two switches for their control.

### List of Reference Numerals

100 casing device
102 receiving space
104 first access opening
106, 106a second access opening
108 casing wall, membrane
110 outer layer
112 inner layer
114 lower section of 200 and part of 100
121 vapor-permeable first wall section
122 second wall section
200 energy storage device, battery
202, 202a electrical connection device
203 energy storage device management system
300 support
401 sensor device
402 pump connection device
403 radio device

1-14. (canceled)

15. A casing device for an energy storage device, comprising:
a casing wall, in particular at least sections of which are configured as a membrane, by means of which a receiving space for accommodating the energy storage device can be delimited in water-tight manner; and
a re-closable first access opening formed in the casing wall for passing the energy storage device into and out of the receiving space,
wherein the casing wall includes a vapor-permeable first wall section and a second wall section, and
wherein the first and the second wall section form a complementary partitioning of the casing wall.

16. The casing device according to claim 15, wherein the first access opening is formed by a re-closable zipper-like separation of the casing wall, which extends along an open or closed line, which extends through the first wall section and/or the second wall section.

17. The casing device according to claim 16, wherein the first access opening:
extends linearly along an open or closed line, or
extends along the open line and divides the casing wall into a third wall section, the third wall section being a cover section formed by at least one flap-like element, and a fourth wall section fixedly connected to said third wall section, wherein the third wall section and the fourth wall section form a complementary partitioning of the casing wall, or
extends along the closed line and divides the casing wall into a third wall section, the third wall section being a removable cover section, and a fourth wall section, the fourth wall section forming a counterpart to the removable cover section, wherein the third wall section and the fourth wall section form a complementary partitioning of the casing wall.

18. The casing device according to claim 15, wherein at least the first wall section of the casing wall comprises at least one inner layer comprised of a Gore-Tex membrane and one outer layer comprised of a Gore-Tex membrane.

19. The casing device according to claim 15, further comprising a second access opening for a substantially water-tight enclosing of an element penetrating said second access opening,
wherein the element is configured as an electrical connection device for establishing an electrical connection, a power connection and/or a control connection to the energy storage device.

20. The casing device according to claim 19, wherein the element is configured as a cable, and wherein the second access opening is part of the third wall section or the fourth wall section.

21. The casing device according to claim 19, further comprising an edge region bordering the second access opening, wherein said edge region
is formed from a rubber-like material, or
is formed from a material which can contract when heated and/or expand when cooled, or
is formed from a thermoplastic or a shape-memory polymer.

22. The casing device according to claim 15, further comprising a sensor device for detecting temperature and atmospheric moisture in the receiving space,

23. The casing device according to claim 22, wherein the sensor device is arranged within the casing device.

24. The casing device according to claim 22, further comprising a short-range radio device configured to exchange control data and/or acquired data with the energy storage device and/or the sensor device.

25. The casing device according to claim 15, further comprising a pump connection device configured to be connected to an independent pump for generating a negative pressure in the receiving space to aspirate a volume of fluid from the receiving space.

26. The casing device according to claim 15, further comprising a fastener including at least one loop or eye configured to fix the position of the casing device, one of the electrical devices disposed therein and/or the energy storage device.

27. An arrangement comprising:
a casing device according to claim 15 and an energy storage device accommodated in said casing device, wherein the energy storage device is configured as a rechargeable battery having at least one electrochemical storage cell for the need-adaptive releasing of electrical energy to a load.

28. The arrangement in accordance with claim 27, wherein the energy storage device is connected, via one of said electrical connection devices, to an energy storage device management system configured to control the release of electrical energy as a function of at least the moisture, atmospheric humidity, and/or temperature detected by a sensor device, wherein the electrical connection device extends through a second access opening of the casing device.

29. The arrangement in accordance with claim 28, wherein the energy storage device management system
is arranged in the casing device, and/or
is configured to be signal-connected to said sensor device for exchanging control data and/or acquired data via one or more radio devices.

30. A method for protecting an energy storage device having a casing device in accordance with claim 15, comprising the steps:
opening the first access opening and arranging the energy storage device in the casing device;
passing one of said electrical connection devices through a second access opening;
electrically connecting the electrical connection device to the energy storage device and closing the second access opening in substantially water-tight manner;
closing the first access opening; and
aspirating a portion of a gas present in the receiving space, out of the receiving space, by generating a negative pressure in the receiving space via an independent pump.
